(19) United States
(12) Patent Application Publication
(10) Pub. No.: US 2015/0280505 A1
(43) Pub. Date: Oct. 1, 2015

(54) Axial Gap Dynamoelectric Machine

(71) Applicant: HITACHI, LTD., Tokyo (JP)

(72) Inventors: Yuichiro Tanaka, Tokyo (JP); Takashi Ishigami, Tokyo (JP)

(21) Appl. No.: 14/433,218

(22) PCT Filed: Oct. 1, 2013
(86) PCT No.: PCT/JP2013/076683

§ 371 Date: Apr. 2, 2015

(30) Foreign Application Priority Data
Oct. 3, 2012 (JP) 2012-221124

(51) Int. Cl. H02K 3/28

(52) U.S. Cl. CPC H02K 3/28

(57) ABSTRACT

An axial gap dynamoelectric machine is provided with a stator core in which continuously wound coils (10a, 10d, 10g, 10j) including a plurality of coils formed of continuously wound insulation-coated conductor wire are disposed in a circumferential direction with the continuously wound coils of the three phases overlapped. With the respective coils being disposed in a radiating shape, the continuously wound coils are configured so that on the inner diameter side of the coils, the insulation-coated conductor wires are continuously wound to adjacent coils via crossover wires (15U2, 15U3, 15U4, 15U5), and the coils are bent in the vertical direction and the continuously wound coils of each phase are made to overlap with each other so that the length (2×L₃+L₂) of the crossover wires can be adjusted regardless of the core layer thickness (L₁) of the stator core. This configuration makes it possible to reduce copper loss, achieve a price reduction and improve durability, insulation properties and cooling performance of the axial gap dynamoelectric machine.

### TECHNICAL FIELD

The present invention relates to an axial gap dynamoelectric machine used as a motor or a dynamo or the like.

### BACKGROUND ART

In recent years, as global warming is becoming more and more serious, there is a growing demand for more energy-saving electric apparatuses. Power consumption by motors accounts for approximately 55% of annual power consumption in Japan, and therefore there is currently a high level of attention to highly efficient motors. Designs using rare earth magnets having a high energy product have been adopted so far to attain highly efficient motors.

However, prices of Nd (neodymium) and Dy (dysprosium) which are raw materials of rare earth magnets are rising in recent years due to the export ceiling control by China which is the world's largest producer. The export control policy by China is intended to prevent environmental destruction caused by extraction of Nd and Dy, and rising prices of rare earths and supply shortage are likely to continue in the future.

For this reason, axial gap motors are getting attention as one of means capable of realizing highly efficient motors using only ferrite magnets instead of rare earth magnets. Axial gap motors allow a wider magnet area to be secured than conventional radial gap ones, and can thereby compensate for deterioration in holding power when rare earth magnets are replaced by ferrite magnets and achieve efficiency equivalent to or higher than conventional efficiency.

An axial gap motor is configured in various combinations such as 1-rotor/2-stator type, 2-rotor/1-stator type and 1-rotor/1-stator type.

Patent Literature 1 described below shows a configuration in which four coils of the same phase are continuously wound and an axial gap motor (1-rotor/1-stator type) is formed using a Y-connection, and which is intended to reduce the motor price by reducing the number of connection points using the continuous winding. Moreover, by gathering crossover wires for connecting the coils on the inner diameter side of the coils, the coil outside diameter side is used as a free space and cooling performance is improved by causing the coil outside diameter side to contact the motor housing.

FIG. 9 shows a winding device for manufacturing conventional four continuously wound coils corresponding to one phase.

In this winding device, four winding bobbins are arranged in a line and mounted in split core back-and-forth adjustment mechanisms 21a, 21b, 21c and 21d that drive these bobbins back and forth. FIG. 9 describes, as an example, a state after completing winding of up to a third core and immediately before starting winding of a fourth core.

A nozzle 24a that supplies an insulation-coated conductor wire has a mechanism for transfer in three axial directions, can form inter-core crossover wires, and in this example, suppose the nozzle 24a is fixed and winding is performed by rotating an entire winding portion including a work. It goes without saying, however, that similar four continuous coils can be formed using a scheme in which the nozzle is rotated.

After completion of winding of the third core, the split core back-and-forth adjustment mechanism 21c is made to retreat as illustrated, the split core back-and-forth adjustment mechanism 21d equipped with an empty bobbin is then made to move forward by a distance that a winding path can be secured. At this time, a crossover wire 25U4 is fixed by fixing pins 22e and 22f, but to secure the winding path, the split core back-and-forth adjustment mechanism 21d needs to move at a stroke equal to or greater than a core layer thickness L1 of each core, and therefore the length of the crossover wire 25U4 is at least the core layer thickness L₁ or more.

Once the crossover wire 25U4 is fixed by the fixing pins 22e and 22f, by rotating the entire winding portion around the split core back-and-forth adjustment mechanism 21d as a center, it is possible to wind the insulation-coated conductor wire around the bobbin.

After completion of winding, the wire is cut at an end of the winding, the split core back-and-forth adjustment mechanism 21d is made to retreat to its original position and the winding is thereby completed. At this time, the crossover wire 25U4 is detached from the fixing pins 22e and 22f as with the crossover wires 25U2 and 25U3, and remains floating.

### CITATION LIST

### Patent Literature

Patent Literature 1: Japanese Patent Laid-Open Publication No. 2008-172859

### SUMMARY OF INVENTION

### Technical Problem

After completion of the winding corresponding to the four cores, when a case of assembling a dynamoelectric machine is assumed as will be described later using FIG. 4, if the core layer thickness of the stator core is the length of the crossover wire in the diameter direction is L₃, and the length in the circumferential direction is L₂, an ideal length L of the crossover wire is 2×L₃+L₂.

However, as described above, since the length of the crossover wire is inevitably the core layer thickness L₁ or more due to a minimum stroke of the split core back-and-forth adjustment mechanism in the winding device, if this length is greater than 2×L₃+L₂, an excess portion is generated, which causes mutual interference, making it difficult to assemble the four continuously wound coils corresponding to three phases. From the standpoint of providing a dynamoelectric machine with high output, when the length L₃ of the crossover wire in the diameter direction and the length L₂ of the crossover wire in the circumferential direction are minimized or the core layer thickness L₁ is increased to increase the lamination factor by applying high-density winding to each coil, there has been a problem that the excess portion of the crossover wire increases significantly, the crossover wires cause interference when continuously wound coils are created and assembled around the shaft, making assembly extremely difficult or causing durability or insulation properties to deteriorate.

It is therefore an object of the present invention to provide an axial gap dynamoelectric machine capable of simply assembling, in an axial direction, a continuously wound coil densely wound with an insulation-coated conductor wire, reducing copper loss and reducing the price of the dynamoelectric machine by optimizing the length and arrangement of crossover wires, improving durability and insulation properties, and further improving cooling performance.

### Solution to Problem

In order to attain the object described above, an axial gap dynamoelectric machine of the present invention is provided with a stator core in which continuously wound coils including a plurality of coils formed of continuously wound insulation-coated conductor wire are disposed in a circumferential direction with the continuously wound coils of three phases overlapped, in which with the respective coils being disposed in a radiating shape, the continuously wound coils are configured so that on the inner diameter side of the coils, the insulation-coated conductor wires are continuously wound to adjacent coils via crossover wires, and the coils are bent in a vertical direction and the continuously wound coils of each phase are made to overlap with each other so that the length of the crossover wires can be adjusted regardless of the core layer thickness of the stator core.

When each coil is bent in the vertical direction and continuously wound coils of each phase are overlapped with each other, if neutral points which are winding start ends of the insulation-coated conductor wires in each phase are arranged so as to be adjacent to each other in the inner circumference of the stator core, it is possible to integrate connection points into one point and further reduce the price of the motor.

The length of the crossover wire is adjusted using the fixing pins provided in a winding jig that holds each cons in a radiating shape, and it is thereby possible to construct the crossover wire having an optimum shape and length.

When bending each coil in the vertical direction and causing the continuously wound coils in each phase to overlap with each other, the crossover wire of the continuously wound coil in the circumferential direction is formed into an arc shape, and it is thereby possible to keep the distance constant in the diameter direction between the rotation shaft of the rotor and the crossover wire and further improve insulation properties.

Furthermore, when each coil is bent in the vertical direction and the continuously wound coils in each phase are caused to overlap with each other, the crossover wires in each phase are disposed so as not to cause interference, and it is thereby possible to secure the spatial insulation distance.

### Advantageous Effects of Invention

As described above, according to the present invention, in order to provide a dynamoelectric machine with higher output, even when the length of the crossover wires in the diameter direction and length in the circumferential direction are minimized or the core layer thickness is maximized, it is possible to adjust the length of the crossover wires regardless of the core layer thickness of the stator core to increase the occupancy by densely winding a wire, and thereby reduce the price of the axial gap dynamoelectric machine, reduce copper loss, improve cooling performance and further increase durability and reliability.

### BRIEF DESCRIPTION OF DRAWINGS

FIG. 1 is a schematic diagram illustrating an arrangement of crossover wires of coils in each phase of a motor with a 12-slot motor which is an embodiment of the present invention.

FIG. 2 is a connection wiring diagram of coils in each phase of a 12-slot motor which is an embodiment of the present invention.

FIG. 3 is a schematic diagram illustrating an arrangement of four continuously wound coils of a U phase which is the embodiment of the present invention.

FIG. 4 is a perspective view illustrating an arrangement of the four continuously wound coils of a U phase which is the embodiment of the present invention.

FIG. 5 is a perspective view illustrating an arrangement of the four continuously wound coils of a U phase which is the embodiment of the present invention when the core layer thickness is greater than the length of the crossover wires.

FIG. 6 is a perspective view illustrating a configuration of a winding device for manufacturing four continuously wound coils corresponding to one phase, which is the embodiment of the present invention, also applicable to a case where a core layer thickness is greater than the length of the crossover wire.

FIG. 7 is a diagram illustrating each coil of the four continuously wound coils corresponding to one phase, which is the embodiment of the present invention, with each coil turned back by 90° vertically within the vertical plane in the diameter direction using the crossover wire as a reference.

FIG. 8 is a cross-sectional view of a first coil at the start of winding illustrating crossover wires of the continuously wound coils corresponding to two phases, which is the embodiment of the present invention, tilted in advance at different angles in the axial direction and the four continuously wound coils corresponding to three phases assembled in the axial direction.

FIG. 9 is a perspective view illustrating a conventional winding device for manufacturing four continuously wound coils corresponding to one phase.

### DESCRIPTION OF EMBODIMENTS

Hereinafter, an embodiment will be described with reference to the accompanying drawings.

### Embodiment

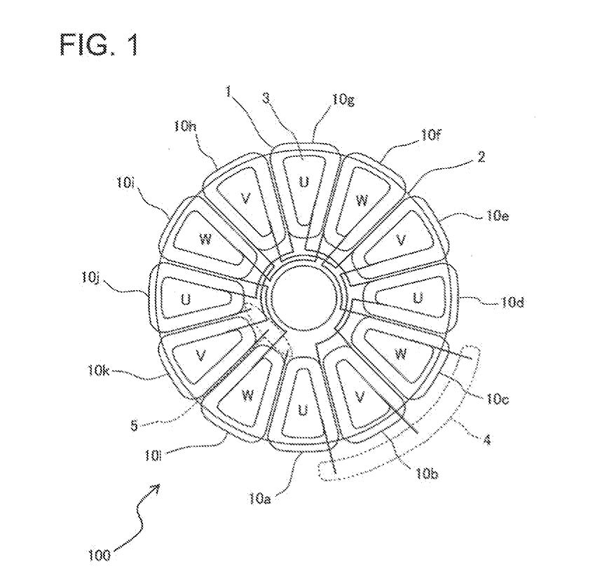

FIG. 1 schematically illustrates an arrangement of crossover wires of coils of each phase of a 12-slot motor, which is an embodiment of the present invention. The “crossover wire” referred to here is defined as a name of an insulation-coated conductor wire portion that connects neighboring coils of continuously wound coils (FIG. 1 shows four continuously wound coils).

An axial gap motor 100 is provided with a stator core 1 as a stator configured by arranging in a ring shape, four coils with insulation-coated conductor wires continuously wound around an iron core 3, in which a rotor 2 is disposed above and/or below the stator core 1. The rotor 2 is connected to a rotation shaft (not shown) disposed at a center and is disposed at a certain distance from the stator core 1. Though not shown, magnets are disposed in the circumferential direction with the N pole and S pole placed alternately on the stator core side of the rotor 2. Note that the axial gap motor 100, which will be described below, is an example, and it goes without saying that the number of coils in each phase, that is, the number of slots can be changed as appropriate.

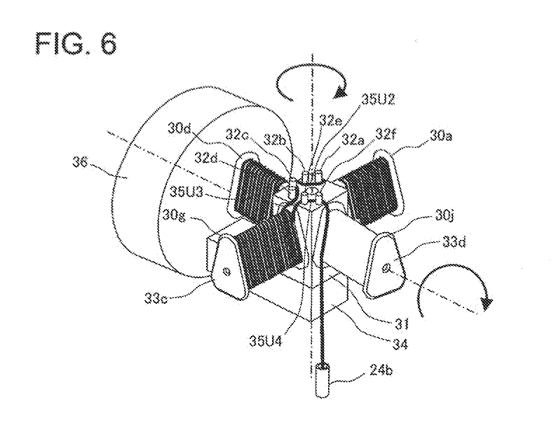

In the embodiment in FIG. 1, four U-phase coils 10a, 10d, 10g and 10j are continuously wound by a winding device, which will be described later using FIG. 6, via crossover wires. Note that the winding direction of the coils is the same for all the coils and all the crossover wires are integrated on the inner diameter side of the coils.

The four V-phase coils 10b, 10e, 10h and 10k and the four W-phase coils 10c, 10f, 10i and 10l also have the same winding direction of continuously wound wires and the same arrangement of crossover wires.

By arranging terminal wires which are wiring starting ends of the four U-phase continuously wound coils, four V-phase continuously wound coils and four W-phase continuously wound coils in mutually neighboring positions and connecting these three phase terminal wires via connection terminals or by welding, it is possible to cause the connected part to function as a neutral point 5.

As a result, it is possible to reduce the number of connection points to one point and thereby reduce the motor price.

By integrating all the crossover wires on the coil inner diameter side, the coil outside diameter side becomes a free space, and it is possible to improve cooling performance of the motor, for example, by making the coil outside diameter side contact the motor housing. Furthermore, since respective input wires 4 of the four U-phase continuously wound coils, four V-phase continuously wound coils and four W-phase continuously wound coils can be necessarily arranged at neighboring positions, it is possible to guide these input wires so as not to contact the rotor 2 and lead them out of a motor case and thereby cause the stator core 1 to function as a stator.

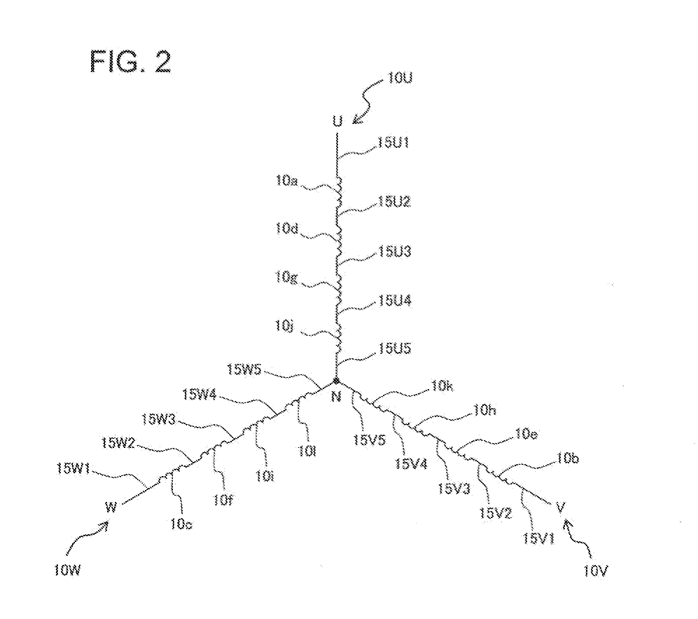

FIG. 2 illustrates a wire connection diagram of the stator core 1 in the axial gap motor 100 of the present embodiment.

A U-phase coil 10U is configured by connecting an input wire 15U1, coil 10a, crossover wire 15U2, coil 10d, crossover wire 15U3, coil 10g, crossover wire 15U4, coil 10j and terminal wire 15U5. The coil winding direction is the same for all the coils. The configuration as well as the coil winding direction is also the same for the V-phase coil 10V and W-phase coil 10W.

That is, the axial gap motor 100 of the present embodiment is made up of a four-series Y-connection using three sets of four continuously wound coils. As described above, the stator core functions as a stator by connecting a central point (N) of the U-phase coil 10U, V-phase coil 10V and W-phase coil 10W as a neutral point.

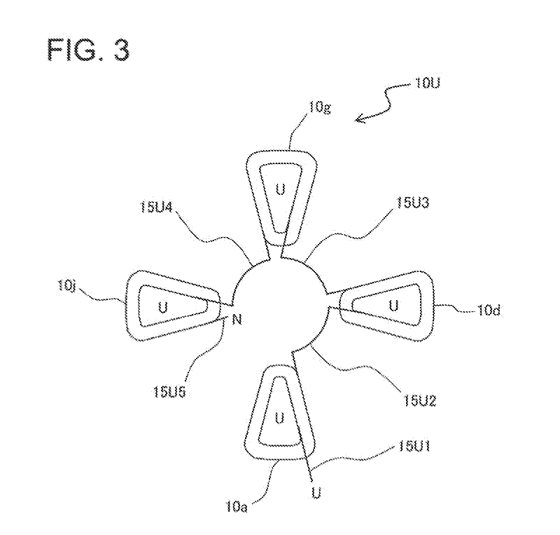

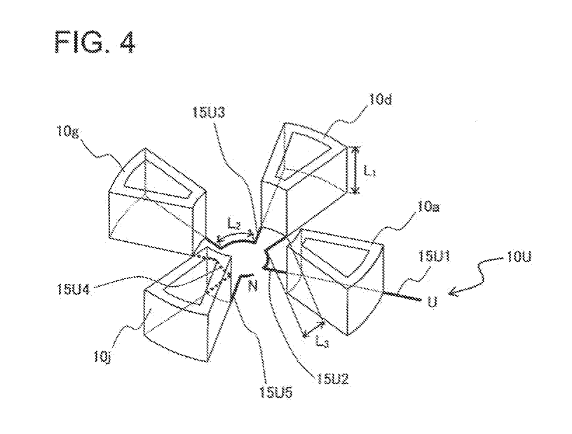

In order to illustrate the structure and arrangement of each four continuously wound coil, FIG. 3 shows a schematic diagram and FIG. 4 shows a perspective view using the coil U phase as an example. It goes without saying that the V-phase coil 10V and the W-phase coil 10W also have the same structure and arrangement.

Here, when a core layer thickness of the stator core 1 is L₁, a length in a diameter direction of the crossover wire is L₃, and a length in a circumferential direction thereof is L₂, and the circumferential direction of the crossover wire is assumed to be disposed along the outer circumference of the rotation shaft of the dynamoelectric machine located at the center, an ideal length L of the crossover wire is 2×L₃+L₂ as is obvious from FIG. 4.

By forming, in advance, the circumferential direction of the crossover wire in an arc shape, it is possible to bend the four continuously wound coils corresponding to three phases in the vertical direction and assemble them in the axial direction centered on the rotation shaft.

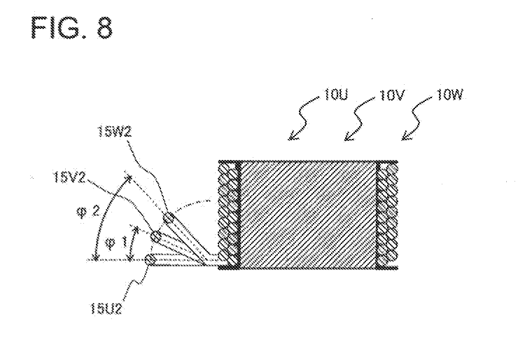

Furthermore, as shown in FIG. 1, in areas where crossover wires cross each other between neighboring U phase and V phase, between neighboring V phase and W phase and between neighboring W phase and U phase, by setting the crossover wires 15U2, 15V2 and 15W2 to different angles with respect to the axial direction of the rotation shaft (15U2 is set to be horizontal, 15V2 is set at angle φ1 and 15W2 is set at angle φ2 in FIG. 8) as shown in the example in FIG. 8, it is possible to prevent interference of wires in the intersection of crossover wires, prevent the wires from contacting each other and reliably prevent short circuits of the wires.

FIG. 6 shows an example of a winding device for realizing an ideal length of the crossover wire when creating four continuously wound coils corresponding to one phase.

Four winding bobbins are arranged at intervals of approximately 90° in the circumferential direction with respect to a winding jig 31. Suppose the central axis of rotation of winding is substantially perpendicular to the axis of rotation of the winding jig 31.

Note that the number of winding bobbins is not limited to four, but can be changed depending on the number of coils of each phase and the angle interval in the circumferential direction may be set so as to adapt to the change.

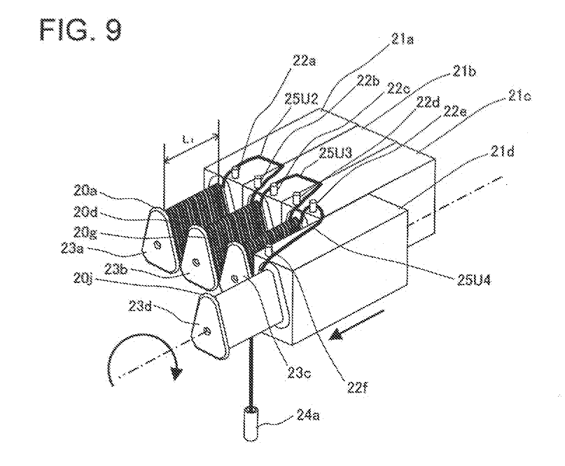

Here, as in the case of FIG. 9, a case will be described as an example where winding of up to a third core is completed and winding of a fourth core is started. In this example, a nozzle 24b that supplies an insulation-coated conductor wire has a mechanism for transfer in three axial directions, so that it can form a crossover wire in any given direction when starting winding onto the next bobbin.

After completion of winding of the third core, the winding jig 31 is made to rotate by 90° around the vertical axis and an empty bobbin is caused to protrude on the axis of rotation of a winding support section 36. At this time, a crossover wire 35U4 is fixed by fixing pins 32e and 32f with a transfer of the nozzle 24b, and wiring of the fourth core is made possible by causing the whole wiring section to rotate around a split core 30j. After completion of the wiring, the winding end wire is cut and the wiring is thereby completed. At this time, the crossover wires 35U2, 35U3 and 35U4 are not detached from the fixing pins and can maintain their desired shapes.

Thus, since the winding bobbins are arranged in a radiating shape, any winding bobbin does not interfere with other winding bobbins during the winding and high-density winding is thereby made possible, and it is also possible to form crossover wires between the roots of the neighboring winding bobbins, and reduce the length L of the crossover wires regardless of the core layer thickness L₁ of the stator core unlike the prior art in which the length L of the crossover wires inevitably become the core layer thickness L₁ or more.

That is, by adjusting the pin shape and arrangement positions of the fixing pins 32e and 32f, it is possible to set the length L of the crossover wires to an ideal length of the crossover wires of 2×L₃+L₂ as shown in FIG. 4 and further form the crossover wires into an arc shape by arranging a plurality of fixing pins on the circumference. It goes without saying that it is possible to use a winding device with the pin shape and arrangement changed for each U phase, V phase and W phase and to adjust the length and shape of the respective crossover wires to appropriate ones.

When arc crossover wires are adopted, it is possible to further improve insulation properties by keeping the distance constant in the diameter direction between the rotation shaft of the rotor 2 and the crossover wires.

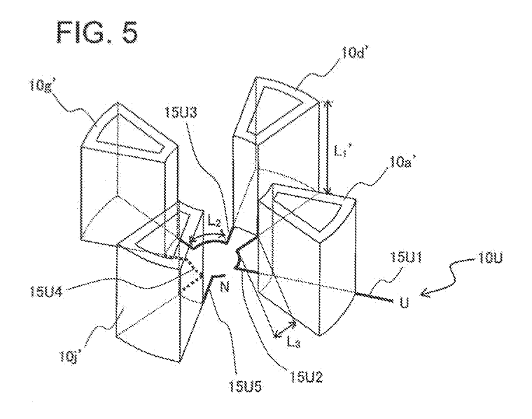

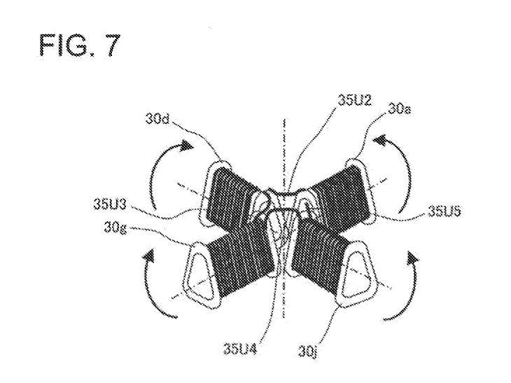

When the winding of the four continuous coils is completed in this way, the four continuous coils are removed from the winding jig, the four continuous coils are then bent by 90° so that each coil is oriented toward the vertical direction within the vertical plane in the diameter direction of each coil with reference to the crossover wires 35U2, 35U3 and 35U4 as shown in FIG. 7, and it is thereby possible to form four continuous coils that can be assembled in the axial direction as shown in FIG. 5 by setting the length L of the crossover wire to, for example, 2×L₃+L₂, while maintaining the crossover wire in a desired shape regardless of the core layer thickness L₁′ which may be large.

Lastly, as shown in FIG. 8, by forming, in advance, the crossover wires 15V2 and 15W2 of the V-phase coil 10V and W-phase coil 10W so as to tilt at different angles φ1 and φ2 in the axial direction with respect to the U-phase coil 10U, it is possible to assemble the four continuously wound coils corresponding to three phases in the axial direction. Here, a minimum value of φ1 is defined by a spatial insulation distance between the U-phase reference coil 10U and the V-phase coil 10V, and a minimum value of φ2 is likewise defined by a spatial insulation distance between the V-phase coil 10V and the W-phase coil 10W.

Instead of this, when the winding end positions of the U-phase coil 10U, V-phase coil 10V and W-phase coil 10W are made to differ from each other and the coils are bent back by 90° so that all the coils are oriented toward the vertical direction, the respective crossover wires may be made to have different heights.

### REFERENCE SIGNS LIST

1 Stator

2 Rotor

3 Iron core

4 Input wire

5 Neutral point

10a to 10l Coil

10U U-phase coil

10V V-phase coil

10W W-phase coil

15U1 Input wire

15U2, 15U3, 15U4 Crossover wire

15U5 Terminal wire

15V1 Input wire

15V2, 15V3, 15V4 Crossover wire

15V5 Terminal wire

15W1 Input wire

15W2, 15W3, 15W4 Crossover wire

15W5 Terminal wire

20a, 20d, 20g, 20j Split core

21a to 21d Split core back-and-forth adjustment mechanism

22a to 22f Fixing pin

23a to 23d Winding bobbin fixing section

24a Nozzle

25U2, 25U3, 25U4 Crossover wire

30a, 30d, 30g, 30j Split core

31 Winding jig

32a to 32f Fixing pin

33c to 33d Winding bobbin fixing section

34 Winding Support section

36 Winding Support section

24b Nozzle

35U2, 35U3, 35U4 Crossover wire

100 Axial gap motor

1. An axial gap dynamoelectric machine comprising:
a stator core in which continuously wound cons comprising a plurality of coils formed of continuously wound insulation-coated conductor wire are disposed in a circumferential direction with the continuously wound coils of three phases overlapped,
wherein with the respective coils being disposed in a radiating shape, the continuously wound coils are configured so that on the inner diameter side of the coils, the insulation-coated conductor wires are continuously wound to adjacent coils via crossover wires, and
the coils are bent in a vertical direction and the continuously wound coils of each phase are made to overlap with each other so that the length of the crossover wires can be adjusted regardless of the core layer thickness of the stator core.

2. The axial gap dynamoelectric machine according to claim 1, wherein when each coil is bent in the vertical direction and continuously wound coils of each phase are overlapped with each other, neutral points which are winding start ends of the insulation-coated conductor wire in each phase are arranged so as to be adjacent to each other in the inner circumference of the stator core.

3. The axial gap dynamoelectric machine according to claim 1, wherein the length of the crossover wire is adjusted using fixing pins provided in a winding jig that holds each coil in a radiating shape.

4. The axial gap dynamoelectric machine according to claim 1, wherein when bending each coil in the vertical direction and causing the continuously wound coils in each phase to overlap with each other, the crossover wire of the continuously wound coil in the circumferential direction is formed into an arc shape.

5. The axial gap dynamoelectric machine according to claim 1, wherein when each coil is bent in the vertical direction and the continuously wound coils in each phase are caused to overlap with each other, the crossover wires in each phase are disposed so as not to cause interference.
